(19) United States
(12) Patent Application Publication
(10) Pub. No.: US 2013/0206918 A1
(43) Pub. Date: Aug. 15, 2013

(54) AUXILIARY FLAP ARRANGEMENT AND AERODYNAMIC BODY COMPRISING SUCH AN AUXILIARY FLAP

(71) Applicant: AIRBUS OPERATIONS GMBH, (US)

(72) Inventors: Markus Fischer, Weyhe (DE); Carsten Weber, Bremen (DE)

(73) Assignee: AIRBUS OPERATIONS GMBH, Bremen (DE)

(21) Appl. No.: 13/759,543

(22) Filed: Feb. 5, 2013

Related U.S. Application Data
(63) Continuation of application No. PCT/EP2011/003966, filed on Aug. 8, 2011.
(60) Provisional application No. 61/371,691, filed on Aug. 7, 2010.

(30) Foreign Application Priority Data
Aug. 6, 2010 (DE) 10 2010 033 639.4

(51) Int. Cl. B64C 3/50

(52) U.S. Cl. CPC B64C 3/50
USPC 244/215; 244/213

(57) ABSTRACT

The invention relates to an auxiliary flap arrangement for modifying the profile of an aerodynamic body, in particular the trailing edge of the aerodynamic body. The auxiliary flap arrangement here exhibits at least two auxiliary flaps that can be adjusted by an adjustment device while coupled to each other.

### CROSS-REFERENCE TO RELATED APPLICATIONS

This application claims priority to PCT Application No. PCT/EP2011/003966, filed Aug. 8, 2011, which claims the benefit of the filing date of German Patent Application No. DE 10 2010 033 639.4, filed Aug. 6, 2010, and of U.S. Provisional Patent Application No. US 61/371,691, filed Aug. 7, 2010, the disclosures of which applications are hereby incorporated herein by reference.

### TECHNICAL FIELD

The invention relates to an auxiliary flap arrangement for modifying the profile of an aerodynamic body, in particular the trailing edge of the aerodynamic body.

### BACKGROUND

For example, U.S. Pat. No. 6,565,045 B1 discloses a system that provides a single, small auxiliary flap on the bottom side of an aerodynamic body. The latter can be deployed completely into the flow, and retracted again via a mechanical system. The flow is here influenced exclusively on one side, specifically the bottom side, or the pressure side, of the aerodynamic body. A similar system can also be gleaned from US 2003/0102410 A1. Known from U.S. Pat. No. 6,641,089 B2 is an auxiliary flap that can be folded by 180°. This makes it possible to influence the flow on either the top side, meaning the suction side, of the aerodynamic body, or the bottom side, meaning the pressure side, of the aerodynamic body. The influence is here exerted through complete deployment by about 90° in relation to the respective outer flow contour of the aerodynamic body.

### SUMMARY

The object of the present invention is to provide an auxiliary flap arrangement that resolves the problems of known auxiliary flap arrangements. In particular, the object of the present invention is to provide an auxiliary flap arrangement that improves the efficiency of an aerodynamic body, while simultaneously reducing the drag of the aerodynamic body to a minimum.

The above object is resolved by an auxiliary flap arrangement with the features in independent claim 1, as well as by an aerodynamic body with the features in independent claim 2. The subject matter of the present invention also relates to an aircraft having the features in independent claim 14. Advantageous embodiments may be gleaned from the independent claims.

An auxiliary flap arrangement in the rear area of the aerodynamic body in relation to the direction of flow around the aerodynamic body according to the invention is provided to vary the profile of an aerodynamic body, so as to change the flow around the aerodynamic body in this area. For example, an aerodynamic body comprising the auxiliary flap arrangement according to the invention can be used as vertical tail comprising a rudder for steering an aircraft, or otherwise influencing the flow around an aerodynamic body, e.g., by generating a higher drag, as in the case of brake flaps or, for example, in servo flaps for trim conditions. With an auxiliary flap arrangement in the rear area of the aerodynamic body in relation to the direction of flow around the aerodynamic body according to the invention, the flow around the trailing edge can be improved in such a way that, for example, flaps on the top or bottom side of an aerodynamic body project into the flow and there generate turbulences.

The advantage of an auxiliary flap arrangement according to the invention to all known devices is that, when activated, they can reduce the drag on the aerodynamic body, and hence to reduce fuel consumption during the flight of an aircraft. In addition, the advantage to an aerodynamic body with an auxiliary flap arrangement according to the invention is that the kinematic air discharge condition at the rear end of the aerodynamic body relative to the direction of flow reduces or hinders the tendency of generation of turbulences that would reduce the efficiency of the aerodynamic body, in particular in terms of the lift it generates. For example, in aerodynamic bodies taking the form of rudders, elevators or ailerons, the complete surface of the aerodynamic body can exert its aerodynamic effect for steering an aircraft. The invention improves the disadvantage of solutions of the state of the art, according to which, in the case of rigid aerodynamic bodies, a high aerodynamic power loss makes it impossible for the known auxiliary flaps to achieve a full climbing power.

An auxiliary flap arrangement according to the invention for modifying the profile of an aerodynamic body here exhibits at least a first auxiliary flap and at least a second auxiliary flap. The first auxiliary flap exhibits a first flow outer contour and first mounting means for holding the first auxiliary flap in a first mounting device of the aerodynamic body, with which the first auxiliary flap can be adjusted relative to the aerodynamic body. The second auxiliary flap exhibits a second flow outer contour and a second mounting means for holding the second auxiliary flap in a second mounting device of the aerodynamic body, with which the second auxiliary flap can be adjusted relative to the aerodynamic body. Further provided is an adjustment device designed to couple the adjustment of the first auxiliary flap with the adjustment of the second auxiliary flap in such a way that at least overall, both auxiliary flaps are adjusted oppositely to each other in relation to the chord direction of the aerodynamic body. In other words, the adjustment device is configured in such a way that coupling the two auxiliary flaps with each other activates the one auxiliary flap on the one side of the aerodynamic body and the other auxiliary flap on the other side of the aerodynamic body in relation to its chord direction during the adjustment process. If the aerodynamic body is viewed in relation to its effective flow profile, coupling the two auxiliary flaps by the adjustment device influences the flow on both sides of the aerodynamic body, meaning on both a suction side and pressure side of the aerodynamic body. The coupling established by the adjustment device advantageously involves a forced coupling, so that both auxiliary flaps are advantageously adjusted at the same time. The adjustment movements can here take place both symmetrically and asymmetrically relative to the chord direction of the aerodynamic body. However, the critical factor here regardless of the point in time and precise end position of the adjustment is that both auxiliary flaps be adjusted collectively, so that the flow is also influenced on both sides of the aerodynamic body.

Further advantageously provided is an activation device that is connected with the adjustment device, and activates the latter for adjusting the two auxiliary flaps. The adjustment of the two auxiliary flaps can be coupled both mechanically, and by this activation device, for example via electrical signals. A mechanical coupling can conceivably be established with lever kinematics or other types of mechanical gears. Such mechanical gears can be centrally driven, and via mechanical distributors, which distribute the adjustment forces to both auxiliary flaps. However, it is also possible to drive only one of the auxiliary flaps, and use additional mechanical gears, such as actuators or mechanical levers, to adjust further auxiliary flaps proceeding from the adjustment of the first auxiliary flap.

In this case, adjusting the respective auxiliary flap must be understood to mean that in particular the outer flow contour adjusts relative to the aerodynamic body. An adjustment can here involve both a movement, in particular a rotation, or also a flexible deformation of the outer flow contour. In other words, this changes the profile of the aerodynamic body that is effective for the flow. In particular, the auxiliary flaps are here secured in the rear area of the aerodynamic body, along its chord direction relative to the direction of flow. As a result, the profile of the aerodynamic body can in this way be varied in the rear area, preferably at the end of the aerodynamic body. This means that adjusting the auxiliary flaps expands or widens the trailing edge of the aerodynamic body. This improves the conditions for flow discharge from the aerodynamic body, so that less eddy formation takes place, thereby improving the efficiency of the aerodynamic body relative to its steering properties and/or lift properties.

When using an auxiliary flap arrangement according to the invention in an aerodynamic body, which itself is to be used as a control vane, for example a rudder, aileron or elevator, the enhanced efficiency makes it possible to realize a smaller surface of the aerodynamic body. The smaller surface is accompanied by less aerodynamic drag, in particular during cruising flight operations, but also by a lower weight and thus reduced fuel costs while operating an aircraft. In addition, the adjustment device allows the auxiliary flap arrangement to be moved into positions in the cruising flight mode that generate as little drag, or most advantageously no additional drag, over the entire aerodynamic body. Therefore, the auxiliary flap arrangements are used to improve the aerodynamics of the corresponding aerodynamic body only when needed.

The respective mount with the respective auxiliary flap is here adapted to the respective mounting device of the aerodynamic body. This makes it possible for the mounting or mounting means for all auxiliary flaps to be identical to each other. However, it is also conceivable that various mountings be used in different mounting devices, interacting between the auxiliary flap arrangement and aerodynamic body. A distinction must basically be made between a movable mount and fixed mount. A fixed mount may be advantageous in particular for auxiliary flaps whose outer flow contour can be adjusted with the auxiliary flap, for example due to the flexibility of the auxiliary flap material. For example, the latter can be accomplished via fixed clamping in a mounting device of the aerodynamic body, so that adjustment takes place at least sectionally by virtue of the flexible design of the auxiliary flap itself. In auxiliary flaps made out of a more rigid material, it may be advantageous to design the mounting device in the aerodynamic body as a rotational mount, which in particular defines a mount axis. In such a case, the mounting means is a ball joint or linking section with a partially round cross section, for example, which can be placed in corresponding receptacles in a mounting device in the aerodynamic body. However, other mounting shapes, such as hinge joints or the like, are also possible within the framework of the present invention. It can here be advantageous for the mounting device and adjustment device to coincide at least in part. For example, when using lever kinematics to adjust the auxiliary flaps, the hinged linkages of the individual levers to the respective auxiliary flap can simultaneously form parts of the mounting device.

Providing an auxiliary flap arrangement according to the present invention makes it possible to increase the efficiency of the aerodynamic component. In particular in aerodynamic bodies used as rudder arrangements, for example rudders, elevators or ailerons of an aircraft, increasing the efficiency, meaning the aerodynamic efficiency, makes it possible to reduce the size of the component by up to 6%. In addition to the weight of the aerodynamic body, this also reduces its drag on the flow.

The crucial factor with respect to the present invention is here that the adjustment device couples the two auxiliary flaps together, so that at least overall, both can be adjusted oppositely relative to each other. In other words, this means that both sides of an aerodynamic body are influenced in relation to its chord direction. As opposed to known auxiliary flap arrangements, which only act on a single side of the corresponding aerodynamic body, the present invention provides an easy way to influence the flow on both sides of the aerodynamic body. This makes it possible to influence the flow efficiently, without the corresponding auxiliary flap having to project especially far into the flow around the aerodynamic body. In particular, this increases the efficiency with which the flow is influenced, while at the same time preventing the drag of the corresponding aerodynamic body from rising too intensely. As a consequence, an auxiliary flap arrangement according to the invention offers an efficient compromise between effectively influencing the flow while minimizing the increase in drag of the aerodynamic body as much as possible. In addition, the trailing edge of an aerodynamic body can be expanded in this way, while the adjustment on both sides of the aerodynamic body retains the nature of the profile, in particular during the symmetrical adjustment of the auxiliary flaps.

Let it be noted in particular that the quality according to the invention of the auxiliary flap arrangement can be used not just in movable aerodynamic bodies, meaning in those serving to steer an aircraft, for example. Rather, the auxiliary flap arrangement according to the present invention can also be secured to an aerodynamic body that is immovable relative to an aircraft. The stability of the flow, and hence the stability of the entire aircraft, can here be improved in special aircraft situations without any great elevation in drag. In special instances, the use of steering actions in the aircraft controller can even be prevented in this way, since the elevated stability of the flight status eliminates the need for them. In addition, the lift of the aerodynamic body can be improved in this way, which has a positive effect on the performance of a thusly equipped aircraft in terms of stiffness.

It is advantageous to utilize the invention when using the present invention for aerodynamic bodies that can move relative to an aircraft, for example steering arrangements in the form of rudders, ailerons or elevators, since in particular a lower rudder deflection yields sufficient steering characteristics for the aircraft. Not only can a savings in weight and reduction in drag be achieved for the aerodynamic body itself as a result, but a lower rudder deflection can also cut the corresponding drag down to a minimum, even during the steering phase of an aircraft. This also enables an even more efficient use of the already diminished aerodynamic body.

Providing auxiliary flaps according to the invention on an aerodynamic body fixed in place relative to the aircraft improves the lift. For example, an improved climbing performance can be achieved during takeoff and the ensuing ascent phase. The use of auxiliary flap arrangements according to the invention also enables the utilization of smaller wings with a correspondingly lower weight. For example, improving the climbing performance during a landing approach given smaller wing geometries makes it possible to achieve the necessary lift forces, e.g., so that smaller landing flaps can be used.

Along with saving on weight with respect to the aerodynamic body itself, reducing the size of fixed or movable aerodynamic bodies relative to the aircraft makes it possible to make the elements joined thereto smaller in size, and hence more lightweight. In this way, the corresponding mounting devices and adjustment kinematics can be given a smaller and lighter design for movable aerodynamic bodies. In both movable and fixed aerodynamic bodies, the corresponding mounting devices and corresponding joining elements, such as bolts, rivets or screws, can also be given a smaller, and hence lighter, configuration.

The present invention also relates to an aerodynamic body to be attached to an aircraft with a first assembly contour forming a first outer flow contour and as a second assembly contour forming a second outer flow contour. The two outer flow contours are aligned oppositely to each other relative to the chord direction of the aerodynamic body. The two outer flow contours are here particularly effective as a pressure side and suction side when used in the aerodynamic body, depending on their position.

Also provided is at least one auxiliary flap arrangement according to the present invention that is arranged on an aerodynamic body in such a way that the first outer flow contour of the first auxiliary flap in conjunction with the first assembly contour forms the first outer flow contour of the aerodynamic body. In addition, the second outer flow contour of the second auxiliary flap in conjunction with the second assembly contour forms the second outer flow contour of the aerodynamic body. This yields a correlation of the respective auxiliary flap with the respective outer flow contour of the aerodynamic body. By coupling the two auxiliary flaps with an adjustment device, the respective auxiliary flaps can be adjusted to in this way influence the outer flow contour of the aerodynamic body on both sides. As a result, there is a direct correlation between adjusting the outer flow contour of the respective auxiliary flap and influencing the outer flow contour of the aerodynamic body. The advantages explained in detail above with respect to an auxiliary flap arrangement can hence be applied as beneficially to an aerodynamic body according to the invention. Let it be noted here yet again that the aerodynamic body can involve both an aerodynamic body that is fixed in place and one that can move relative to an aircraft. For example, the latter aerodynamic body can be a steering device, e.g., a rudder, an elevator or an aileron. However, it can also be a fixed wing, for example the primary wing.

It can further be advantageous in an aerodynamic body according to the invention that the auxiliary flap arrangement be arranged on the aerodynamic body in such a way that, viewed in the direction of flow, the two outer flow contours of the two auxiliary flaps form the respective trailing edge section of the first outer flow contour as well as the second outer flow contour of the aerodynamic assembly. Therefore, the rear edge section must be understood as the section lying at the outermost end of the aerodynamic body in relation to its chord direction, as viewed in the direction of flow. This trailing edge section of an aerodynamic body is usually configured in such a way as to converge in a relatively sharp-edged corner. It is especially advantageous to use the auxiliary flap arrangement according to the invention in this area, in particular at the edge-shaped end in the chord direction of the aerodynamic body, meaning in the direction of flow around the aerodynamic body, since its increased efficiency is manifested most strongly at that location.

The trailing edge of the aerodynamic body can thus be changed in this way. Changing the trailing edge directly alters the conditions under which the flow is discharged from the aerodynamic body. As a consequence, changing the discharge also alters the conditions involving the flow around the aerodynamic body, thereby improving its aerodynamic efficiency, for example its steering effectiveness. Using an auxiliary flap arrangement according to the invention adjusts the respective auxiliary flap on both sides of the aerodynamic body. Therefore, the flow is also influenced on both sides of the aerodynamic body, which eliminates a unilateral change in flow, and hence an unfavorable flow distribution around the aerodynamic flow body.

The auxiliary flaps of the auxiliary flap arrangement according to the invention here advantageously form the aerodynamic and/or the structural termination of the aerodynamic body at its trailing edge. Of course, it must here be borne in mind that mechanical and/or structural necessities may cause a small distance to exist between the trailing edge of the respective auxiliary flap in relation to the direction of flow and the trailing edge of the aerodynamic body in relation to the direction of flow.

In an aerodynamic body according to the invention, it is possible that the trailing edge sections comprise less than 40% of the overall respective outer flow contour of the aerodynamic body, when seen in the chord direction of the same, and more than 2% of the overall respective outer flow contour of the aerodynamic body. In particular in this area, using the auxiliary flaps according to the invention is particularly advantageous, since efficiency with respect to the flow around the aerodynamic body can already be increased there with just slight adjusting deflections of the respective auxiliary flap. In particular, it is advantageous if the auxiliary flap arrangement according to the invention in an aerodynamic body according to the invention is designed in such a way that at least one of the outer flow contours of the two auxiliary flaps comprises 1 to 2% of the corresponding outer flow contour of the aerodynamic assembly, when seen in the chord direction of the same. This reduces the size of the auxiliary flaps to a minimum. The weight of the auxiliary flap arrangement is also reduced to a minimum as a result. The size of the influencing surface is also reduced to a minimum, thereby also minimizing the drag generated against the flow around the aerodynamic body. Therefore, such a configuration according to the invention for the auxiliary flap arrangement is accompanied by a minimum increase in weight by the provision of the auxiliary arrangement, wherein the highest possible efficiency can be simultaneously achieved for the auxiliary flap arrangement in relation to the influence exerted on the flow around the aerodynamic body.

It can be advantageous within the framework of the present invention for a first setting angle and a second setting angle to be defined between the tangents on the respective outer flow contour of the two auxiliary flaps and the corresponding assembly contour in the mounting axes formed by the mounting devices, and for the two setting angles to be less than 45° and, in particular, more than 5°. As a consequence, the maximum setting angles achievable by adjusting the outer flow contour, meaning the two auxiliary flaps, can effectively influence the flow around the aerodynamic body on the one hand, while on the other avoiding an inordinately high increase in the drag of the aerodynamic body. The respective maximum setting angles are advantageously identical to each other, so that a symmetrical adjustment of the respective auxiliary flap in relation to the aerodynamic body takes place in this way. In particular, the maximum setting angles can lie in a range of 5 to 10°. Smaller maximum setting angles of at most 5° are here also conceivable.

In an aerodynamic body according to the invention, it can be advantageous for the two trailing edges of the two outer flow contours of the two auxiliary flaps to be connected with a shared covering device in relation to the direction of flow, which is designed in such a way as to cover an opening created by adjusting the two outer flow contours of the auxiliary flaps. In the invention, the auxiliary flaps are situated on the aerodynamic body, so that this opening is located on the trailing edge of the latter. In other words, adjusting the respective auxiliary flap causes the trailing edge of the aerodynamic body to open, forming an opening that extends until just into the aerodynamic body, depending on the design of the aerodynamic body. A cover device according to the invention is provided in order to prevent contaminants from being able to penetrate into the aerodynamic body on the one hand, in particular into movable assemblies, for example those used to adjust the auxiliary flaps, and on the other hand to improve the flow even more. For example, the latter can consist of a flexible material, in particular be designed as a flexible skin or membrane, which comes to lie between the auxiliary flaps when they are folded in completely. While the auxiliary flaps are being adjusted, i.e., while the auxiliary flaps are being deployed, this flexible skin can be moved into a position where it automatically covers the arising opening. This skin here advantageously stretches over the entire opening, and is exclusively secured to the two trailing edges of the auxiliary flaps in the direction of flow. Other embodiments of the cover device are conceivable within the framework of the present invention, for example sliders or other types of mechanical elements.

It can be advantageous in an aerodynamic body according to the invention for the first flow contour of the first auxiliary flap to be adjusted around a first mounting axis of a rotational mounting device and for the second outer flow contour of the second auxiliary flap to be adjusted around the second mounting axis of a corresponding rotational mounting device symmetrically to the tangent at the center line of the aerodynamic body at the point of intersection with the connecting straight line of the two mounting axes. In other words, the center line of the aerodynamic body extends along the chord direction of the latter. Depending on the type of contour of the aerodynamic assembly, the center line M can already involve the tangent, in particular given an aerodynamic body with a symmetrical profile. In the event of asymmetrical profiles, for example aerodynamic bodies that are fixed in place, the center line M can also be a curved line, so that the tangent at this curved center line becomes the decisive factor when considering the symmetry of this embodiment.

Symmetrically adjusting the two auxiliary flaps causes the flow to be influenced identically on both sides of the aerodynamic body. The adjustment devices for coupling the two adjustments and any provided mechanical gears between the auxiliary flaps are here advantageously also designed symmetrically for their mechanical adjustment, thereby reducing the complexity of the auxiliary flap arrangement, and hence the aerodynamic body within the framework of the present invention.

Another advantage could be for the transition of the two outer flow contours of the aerodynamic assembly between the respective assembly contour and respective outer flow contour of the two auxiliary flaps to be continuous and exhibit a constant rise. As a result of the constancy of such a transition, no edge is produced that extends into the flow along the aerodynamic body, and would hence disproportionately increase the drag of the aerodynamic body. A transition that is continuous and constantly rising yields a transition that can progress not just without an edge, but in essentially a uniform manner as well. In particular, changes in curvature are avoided in the transition area in this way, and the flow is improved even further. This can be done in particular by achieving the adjustment of the respective auxiliary flap via a flexible design of the material comprising the mounting device and/or respective auxiliary flap, at least in the region where the auxiliary flap is mounted on the aerodynamic body. In this way, the curved progression of the aerodynamic body can be accommodated in the transition area, and pass over slowly but steadily into a new curved progression of the adjusted auxiliary flap. In other words, even when adjusted, the profile of the auxiliary flap follows the nature of the profile for the outer flow contour of the aerodynamic body.

Another advantage could be for the auxiliary flap arrangement in an aerodynamic body according to the invention to be configured in such a way that the maximum distance achievable by adjusting the two outer flow contours of the two auxiliary flaps between the trailing edges of the two outer flow contours of the two auxiliary flaps relative to the direction of flow measures between 0.4 and 2% of the extension of the aerodynamic assembly along its chord direction. In other words, this makes it possible to achieve especially small changes in the dimensions of the trailing edge of the aerodynamic body. As a result of the latter, the flow is influenced effectively enough on the one hand, with the discharge pattern at the trailing edge of the aerodynamic body being improved in particular, and a minimal additional resistance is produced through the use of the adjusted, meaning deployed, auxiliary flaps of the auxiliary flap arrangement on the other. In other words, especially small and compact auxiliary flaps, and hence an especially lightweight and simple configuration of the auxiliary flap arrangement, make it possible to influence the flow efficiently enough, in particular the discharge at the trailing edge of the aerodynamic body.

It can also be advantageous for the auxiliary flap arrangement in an aerodynamic body according to the invention to be designed in such a way that the maximum distance achievable by adjusting the two outer flow contours of the two auxiliary flaps between the trailing edges of the two outer flow contours of the two auxiliary flaps in relation to the direction of flow achievable by adjusting the two outer flow contours of the two auxiliary flaps lies between 2 to 10 times the minimum distance between the trailing edges of the two counter flow contours of the two auxiliary flaps relative to the direction of flow achievable by adjusting the two outer flow contours of the two auxiliary flaps. This is advantageous, since the trailing edge of an aerodynamic body is never completely sharp-edged for technical reasons, in particular as relate to production. Depending on how the aerodynamic body is dimensioned, trailing edges here commonly exhibit a minimal extension in the thickness direction of the aerodynamic body that measures around 7 mm. Depending on the size of the aerodynamic body, the trailing edge of the aerodynamic body can also exhibit smaller or larger dimensions. For example, 5 or 6 mm or even 8 or 9 mm are conceivable.

The auxiliary flap arrangement according to the invention increases the distance, meaning the size, of the trailing edge. This can advantageously take place continuously up to a maximum value. In particular, the trailing edge is here made up to 2 to 10 times larger than minimal state, i.e., when the auxiliary flaps are folded in. At an initial distance of 7 mm with the auxiliary flaps retracted, it is advantageously possible for the auxiliary flaps to conceivably be adjusted into a position where their two trailing edges exhibit a distance of around 28 mm.

It may be advantageous within the framework of the present invention for the aerodynamic body to be an aerodynamic body that can move relative to an attachment structure of an aircraft. As already explained at the outset, this is one of the ways in which an aerodynamic body according to the invention or auxiliary flap arrangement according to the invention can be used. For example, such a movable aerodynamic body can be a rudder, an elevator or aileron, which is used for steering the aircraft. The advantage to using such a movable aerodynamic body as described in the invention has to do with the reduction in its size, and hence the reduction in its weight. In addition, the aerodynamic effect of the movable assembly is made more efficient, so that smaller deflections with lower drag advantageously yield the same aerodynamic effect, for example the same steering effect.

It is also possible for the adjustment device of the auxiliary flap arrangement in an aerodynamic body according to the invention to be designed in such a way as to couple the adjustment state of the two outer flow contours of the two auxiliary flaps with the state of movement of the aerodynamic body. Therefore, if the aerodynamic body is an aerodynamic body that can move relative to an aircraft, coupling, for example mechanically coupling, the adjustment of the aerodynamic body can also actuate the adjustment of the auxiliary flaps. In this way, a decentralized controller can be realized that requires no additional control commands for adjusting the auxiliary flaps. This provides an especially simple, sparingly error-prone and easily manufactured system. Coupling can then take place mechanically, for example, so that lever kinematics for adjusting the auxiliary flaps are mechanically coupled with lever kinematics for adjusting the aerodynamic body, as a result of which the actuation of lever kinematics for the aerodynamic body is also accompanied by the actuation of lever kinematics for the auxiliary flaps.

Another subject matter of the present invention involves an aircraft comprising at least one aerodynamic body according to the present invention.

### BRIEF DESCRIPTION OF THE DRAWINGS

The invention will be explained in greater detail based on the attached drawings in the figures. The terms “left,”, “right”, “top” and “bottom” used therein here relate to drawings on the figures aligned with normally legible reference numbers. Shown on:

FIG. 1a is a cross section of a first embodiment of an aerodynamic body according to the invention,

FIG. 1b is the embodiment on FIG. 1a with adjusted auxiliary flaps;

FIG. 2 is another embodiment of an aerodynamic body according to the invention;

FIG. 3 is another embodiment of an aerodynamic body according to the invention;

FIG. 4 is another embodiment of an aerodynamic body according to the invention;

FIG. 5a is another embodiment of an aerodynamic body according to the invention;

FIG. 5b is the embodiment on FIG. 5a with adjusted auxiliary flaps;

FIG. 6a is another embodiment of an aerodynamic body according to the invention;

FIG. 6b is the embodiment on FIG. 6a with adjusted auxiliary flaps;

FIG. 7 is another embodiment of an aerodynamic body according to the invention; and

FIG. 8 is another embodiment of an aerodynamic body according to the invention.

### DETAILED DESCRIPTION

In an exemplary embodiment of the invention, apparatus and methods described hereinabove are employed to reduce aerodynamic drag. The present invention has been described using detailed descriptions of embodiments thereof that are provided by way of example and are not intended to necessarily limit the scope of the invention. In particular, numerical values may be higher or lower than ranges of numbers set forth above and still be within the scope of the invention. The described embodiments comprise different features, not all of which are required in all embodiments of the invention. Some embodiments of the invention utilize only some of the features or possible combinations of the features. Alternatively or additionally, portions of the invention described/depicted as a single unit may reside in two or more separate physical entities which act in concert to perform the described/depicted function. Alternatively or additionally, portions of the invention described/depicted as two or more separate physical entities may be integrated into a single physical entity to perform the described/depicted function. Variations of embodiments of the present invention that are described and embodiments of the present invention comprising different combinations of features noted in the described embodiments can be combined in all possible combinations including, but not limited to use of features described in the context of one embodiment in the context of any other embodiment. Specifically, features described in the context of a method can be used to characterize an apparatus and features described in the context of an apparatus can be used to characterize a method. The scope of the invention is limited only by the following claims. In the description and claims of the present application, each of the verbs “comprise”, “include” and “have” as well as any conjugates thereof, are used to indicate that the object or objects of the verb are not necessarily a complete listing of members, components, elements or parts of the subject or subjects of the verb. All publications and/or patents and/or product descriptions cited in this document are fully incorporated herein by reference to the same extent as if each had been individually incorporated herein by reference.

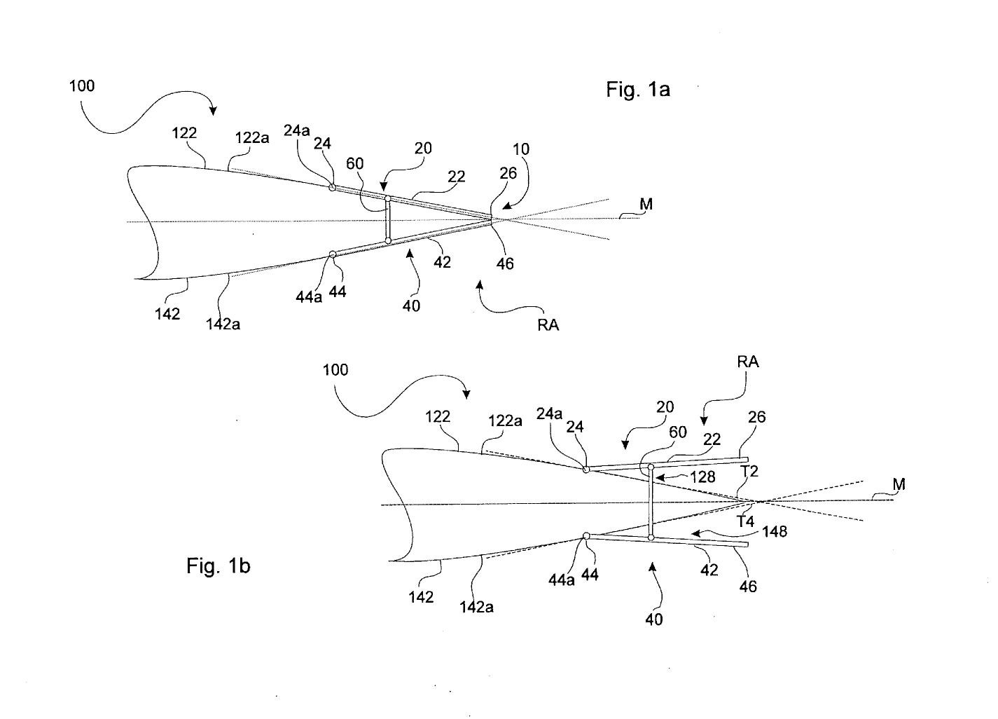

FIGS. 1a and 1b show a first embodiment of an aerodynamic body 100 according to the invention. FIGS. 1a and 1b differ in terms of the respective adjustment state of the two auxiliary flaps 20 and 40. FIG. 1a shows the state in which the two auxiliary flaps 20 and 40 are completely folded in, meaning adapted to the outer flow contour 122a and 142a of the aerodynamic body 100. FIG. 1b depicts the auxiliary flaps 20 and 40 completely folded, meaning in a state where the two auxiliary flaps 20 and 40 exert the greatest effect on the aerodynamics around the aerodynamic body 100.

In this embodiment, the auxiliary flap arrangement 10 in an aerodynamic body 100 exhibits two auxiliary flaps 20 and 40. The latter are coupled together via an adjustment device 60. The adjustment device 60 on FIGS. 1a and 1b is diagrammatically depicted. For example, it can consist of lever kinematics or telescoping mechanisms, enabling the adjustment of the two auxiliary flaps 20 and 40, which are shown in a position on FIG. 1b, for example.

Each of the two auxiliary flaps 20 and 40 exhibits an outer flow contour 22 and 44 that faces the side of the aerodynamic body 100, around which a flow streams. At the same time, the aerodynamic body 100 also exhibits a first assembly contour 122 and second assembly contour 142, which each have an outer flow contour 122a and 142a for the entire aerodynamic body 100. The outer flow contour 122a and 142a of the aerodynamic body 100 is hence formed by its respective assembly contour 122 or 142, as well as by the outer flow contours 22 and 42 of the two auxiliary flaps 20 and 40.

Each of the auxiliary flaps 20 and 40 is arranged in mounting devices 24 and 44 by mountings or structures 24a and 44a. In the embodiment shown on FIGS. 1a and 1b, the mounting devices are hinge joints, in which a mounting 22a and 42a is introduced like a hinge in the form of an essentially partially round cross section of the auxiliary flaps 20 and 40. The latter define a mounting axis that extends essentially perpendicular to the drawing plane on FIGS. 1a and 1b. The respective auxiliary flap 20 and 40 can be rotated around this mounting axis in the mounting devices 24 and 44, enabling them to be adjusted between various positions. In the two extreme cases, rotation can end with the auxiliary flaps 20 and 40 completely retracted, or folded in, according to FIG. 1a, or with the auxiliary flaps 20 and 40 essentially folded out completely, as depicted on FIG. 1b.

Regardless of the actual adjustment situation relative to the respective auxiliary flap 20 and 40, the outer flow contour 122a and 142a of the aerodynamic body 100 is always formed by combining the assembly contour 122 and 142 with the outer flow contour 22 and 42 of the respective auxiliary flap 20 and 40. As a result of this strict definition, the profile of the aerodynamic body 100 can be varied by adjusting the auxiliary flaps 20 and 40. As a consequence, not only can the profile be varied, but beyond that the aerodynamics of the aerodynamic body 100 can be changed as well.

In the embodiment on FIGS. 1a and 1b, the auxiliary flaps 20 and 40 are arranged in its trailing edge area RA. The auxiliary flaps 20 and 40 are influenced with an especially high efficiency in this very area, since the discharged flow around the aerodynamic body 100 can be influenced there. In other words, adjusting the two auxiliary flaps 20 and 40 allows the auxiliary flap arrangement 10 to vary the discharge. The aerodynamic body 100 on FIG. 1a is in an uninfluenced state, while FIG. 1b depicts the state in which the auxiliary flaps 20 and 40 exert the maximum influence.

As may be readily gleaned from FIGS. 1a and 1b, adjusting the two auxiliary flaps 20 and 40 expands the trailing edge of the aerodynamic body 100. It expands between a minimum value depicted on FIG. 1a and a maximum value depicted on FIG. 1b. Expanding the trailing edge of the aerodynamic body 100 improves the discharge characteristics of the flow around the aerodynamic body 100, thereby increasing its aerodynamic efficiency.

For example, the aerodynamic body 100 can be a steering device, e.g., a rudder, an elevator or an aileron. In such a case, the overall surface, and hence the overall weight, of the aerodynamic body can be reduced by increasing the aerodynamic efficiency of the aerodynamic body 100. The auxiliary flap arrangement 10 is here advantageously arranged only in the trailing edge section RA of the aerodynamic body 100. This trailing edge section RA is advantageously smaller than 40%, in particular less than 2%, relative to the overall extension of the aerodynamic body 100 in the chord direction.

The auxiliary flap arrangement 10 according to the invention is advantageously used as follows: Given an aerodynamic body 100 that does not need to be influenced, for example an aerodynamic body 100 in the form of a rudder that is not required for steering, meaning is not outwardly deflected, the auxiliary flap arrangement 10 is in the completely retracted state, for example as depicted on FIG. 1a. In this state, the trailing edge of the aerodynamic body 100 is not expanded, so that the auxiliary flap arrangement 10 also does not influence the flow.

If the rudder in the form of the aerodynamic body 100 is deflected, for example to implement a control signal, the auxiliary flaps 20 and 40 are subsequently or simultaneously also adjusted. The adjustment advantageously depends on the magnitude of adjustment, meaning on the deflection of the aerodynamic body 100 in the form of a rudder. In other words, this means that the more the rudder is deflected, the more the auxiliary flaps 20 and 40 are also adjusted. FIG. 1b shows the adjusted auxiliary flaps 20 and 40 in such a state, preferably at maximum deflection. Although the embodiment on FIG. 1b shows a symmetrical deflection of the two auxiliary flaps 20 and 40, the present invention is not limited to such a symmetrical deflection. Rather, asymmetrical deflections are also conceivable.

With respect to how an auxiliary device 10 according to the invention functions, it is crucial that the two auxiliary flaps 20 and 40 be oppositely adjustable in relation to the chord direction of the aerodynamic body 100. In this way, they influence the flow on both sides of the aerodynamic body 100, meaning on its pressure side and suction side, thereby establishing an adjustable outer flow contour 122a and 142a on both sides of the aerodynamic body 100.

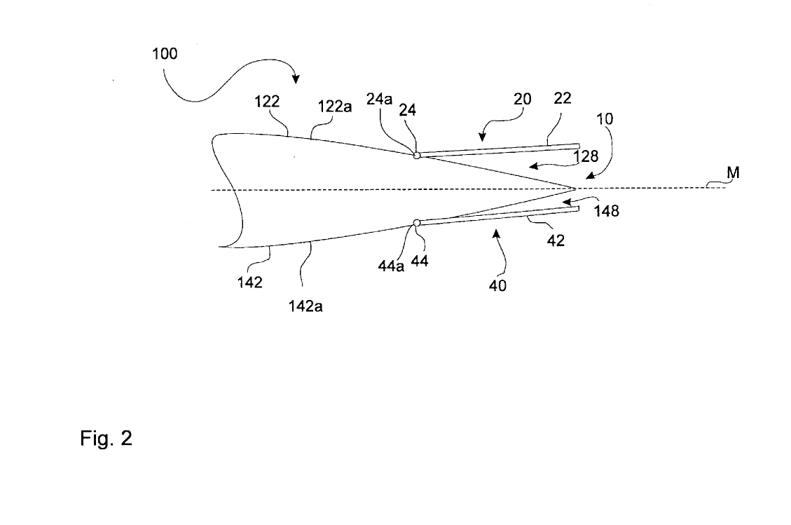

FIG. 2 shows a variant of the embodiment from FIG. 1, specifically in a form in which the two auxiliary flaps 20 and 40 are adjusted asymmetrically. In this embodiment, the lower auxiliary flap 40 is not adjusted as far out as the upper auxiliary flap 20. For example, this asymmetrical deflection can be advantageous in cases where the goal is to exert an asymmetrical influence via the asymmetrical steering characteristics of the respective aerodynamic body 100. While rudders usually are designed to perform similar control commands in both directions in order to turn an aircraft to the left or right, it can be advantageous for the elevators or ailerons to exhibit asymmetrical auxiliary flap arrangements 10 to provide aerodynamic support for asymmetrical control commands for the respective deflection of the aerodynamic body 100. The symmetry with which the auxiliary flaps 20 and 40 are adjusted is here related to the center line M in the chord direction of the aerodynamic body 100. However, this is only the case for symmetrical flow profiles of the aerodynamic body 100 in which the tangent on the center line M coincides with this center line M at the intersecting point in the connection between the two mounting devices 44 and 42. In asymmetrical flow profiles of the aerodynamic body 100, the tangent in this respective intersecting point S is pivotal, as has yet to be explained later.

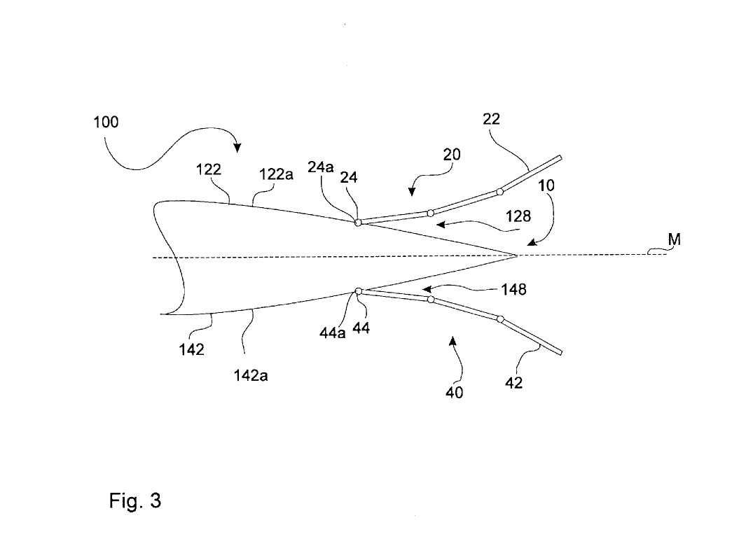

FIG. 3 presents another embodiment of an aerodynamic body 100 according to the invention. The latter is distinguished by the fact that a variant of the auxiliary flap arrangement 10 is utilized. In this variant, the auxiliary flaps 20 and 40 are divided into multiple segments. Three individual parts of the respective auxiliary flap 20 are provided here, which are hinged together. In this way, the trailing edge of the aerodynamic body 100 can be expanded especially broadly, without having to lengthen the outer flow contour 22 and 42 of the respective auxiliary flap 20 and 40. The entire flow contour 122a and 142a of the aerodynamic body is hence essentially constant, and essentially continuously rising. This enables the most efficient expansion of the trailing edge of the aerodynamic body 100 as possible on the one hand, while simultaneously providing the most compact possible embodiment of the auxiliary flap arrangement 10 on the other. The latter can be arranged in the outermost end region in relation to the direction of flow in terms of the chord direction of the aerodynamic body 100. In particular, this is conceivably possible in an area making up only 2 to 5% of the entire expansion of the aerodynamic body 100 in its chord direction. Configuring the auxiliary flaps 20 and 40 to have multiple hinges makes it possible to expand the trailing edge of the aerodynamic body 100 widely enough, despite this very small geometric section.

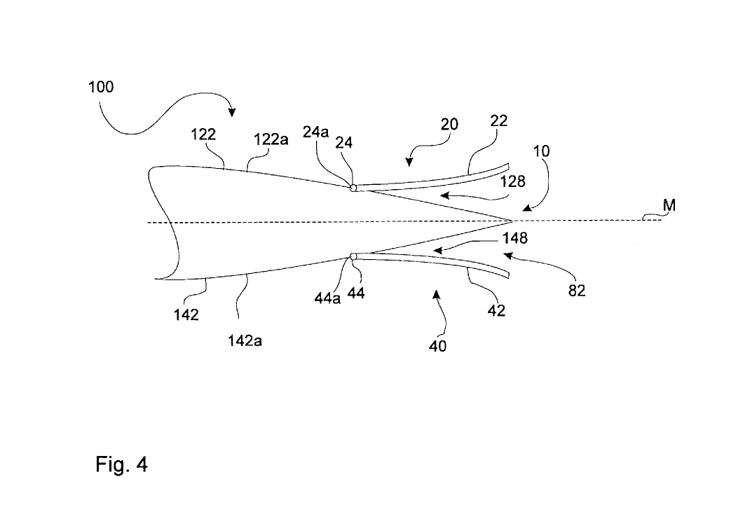

FIG. 4 depicts another embodiment of an aerodynamic body 100 according to the invention. This embodiment makes use of another variant of the auxiliary flap arrangement 10. This embodiment is based on a flexible material configuration of the auxiliary flaps 20 and 40. They are advantageously equipped with a first mounting 24a and second mounting 44a, which are rigidly clamped as a mounting device 24 or mounting device 44, secured to the aerodynamic body 100. This enables an essentially constant transition with a virtually uninterruptedly continuous rise between the assembly contour 122 and 142 of the aerodynamic body 100 and the outer flow contour 22 and 44 of the respective auxiliary flap 20 and 40. This reduces the drag in this transitional area to a minimum, while at the same time allowing an effective expansion of the trailing edge of the aerodynamic body 100. For example, the flexibility can be achieved with partially flexible materials, or partially flexible structures of the respective auxiliary flap 20 and 40. Multi-component materials are conceivable for such assemblies, for example those fabricated out of a matrix cast with resin. Also possible within the framework of the present invention are lamellar reinforcements, which only allow flexibility in one bending direction, specifically in the desired bending direction for adjusting the auxiliary flaps 20 and 40.

As readily evident from the auxiliary flaps 20 and 40 portrayed on FIG. 4, an angle 128 and 148 forms as the maximum setting angle between the tangents T2, T4 in the respective coupling point of the respective auxiliary flap 20 and 40 to the assembly contour 122 and 142, as well as the tangent in the respective coupling point to the respective auxiliary flap 20 and 40. These setting angles define the setting in the respective coupling point.

Depending on whether the auxiliary flap 20 and 40 involves a constantly curved, non-curved or variably curved auxiliary flap 20 or 40, this setting angle 128 and 148 also corresponds to the remaining setting angles over the progression of the auxiliary flap 20 or 40. Depending on the material selected and the configuration of the auxiliary flap 20 and 40, the trailing edge of the aerodynamic body 100 can hence be correspondingly expanded as a function of the respective setting angle 128 and 148.

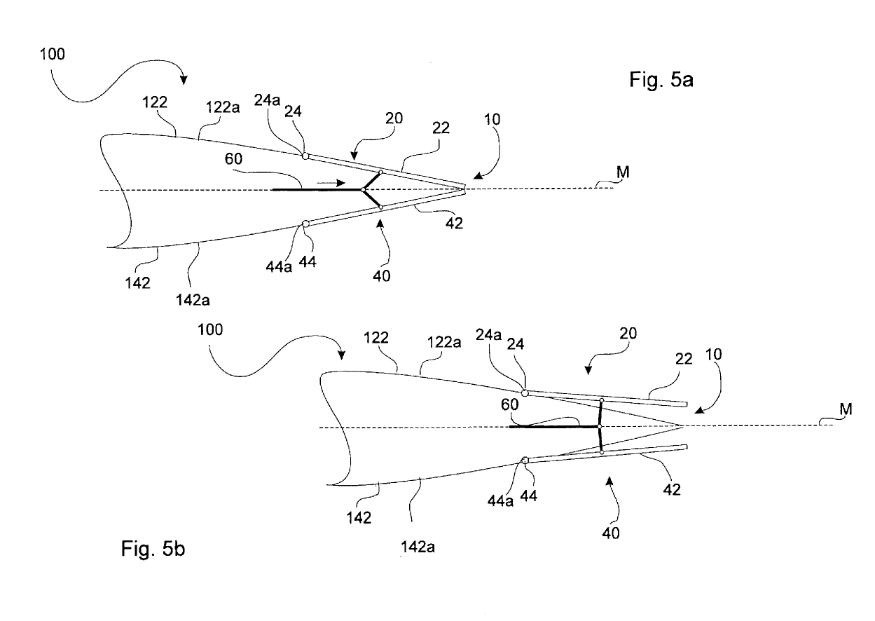

FIGS. 5a and 5b depict a variation of the embodiment on FIGS. 1a and 1b. Shown here is another embodiment of the adjustment device 60. In this embodiment, the adjustment device 60 is designed as lever kinematics. The latter lever kinematics are symmetrically configured, so that a central lever and intermediate joint hinge two short levers with the two auxiliary flaps 20 and 40. By moving the central lever of the adjustment device 60 along the chord direction of the aerodynamic body 100, its hinged connection makes it possible to vary the two short levers in their angular setting relative to the central lever. The hinged connection to the respective auxiliary flap 20 and 40 causes the latter to be deployed or retracted, or adjusted. On FIG. 5a, the two auxiliary flaps 20 and 40 are in a completely retracted position. When the central lever of the adjustment device 60 is now moved, toward the right on FIG. 5a, it moves the two short levers to the outside via the central hinge joint. The additional hinged connection between the short levers and respective auxiliary flap 20 and 40 causes the latter to be deployed, and the entire kinematics move into a position as depicted on FIG. 5b. This process is reversible, so that pulling the central lever of the adjustment device 60 to the left on FIG. 5a makes it possible to adjust the two auxiliary flaps 20 and 40 back to the end position, so that they move to the position shown on FIG. 5a.

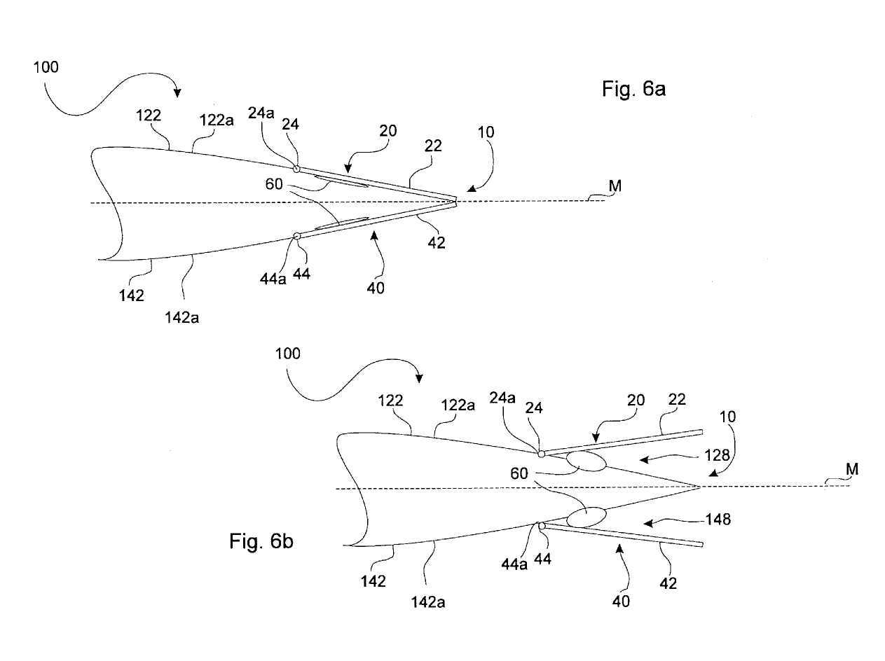

FIGS. 6a and 6b depict another variation of the auxiliary flap arrangement 10, wherein the function of the adjustment device 60 is here ensured by a type of bellows. The adjustment device 60 here exhibits at least two air chambers, which are clamped between an assembly structure of the aerodynamic body 100 on the one hand and the respective auxiliary flap 20 and 40 on the other. Ventilating, or inflating, the respective air chamber forces the auxiliary flaps 20 and 40 to the outside, thereby adjusting them. When air is once more discharged from the respective air chambers, the respective auxiliary flaps 20 and 40 again move back to the initial position as depicted on FIG. 6a. In the event that just releasing air is not enough, let it be noted that the flow on the outside of the respective auxiliary flap 20 and 40 forces the latter back into the position according to FIG. 6a in response to the generated drag.

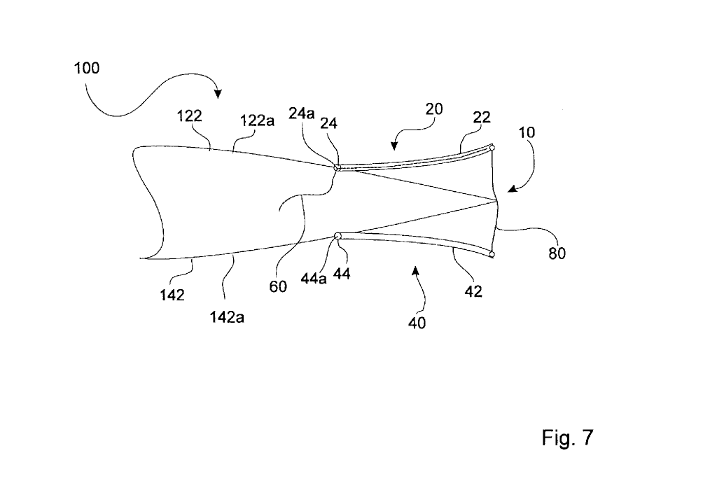

FIG. 7 shows another embodiment of an auxiliary flap arrangement 10 according to the invention, wherein the opening 82 at the trailing edge of the aerodynamic body 100 is here covered by a cover device 80. This cover device 80 is made at least in its principal form out of flexible material, so that it extends between the two trailing edges of the respective auxiliary flap 20 and 40 in relation to the direction of flow. Since the trailing edge of the aerodynamic body 100 is maximally extended in this state, the opening 82 is correspondingly also present in its maximum size. To prevent contaminants from being able to penetrate into this opening 82, the cover device 80 is configured in such a way as to span this opening 82 and preclude this. When the two auxiliary flaps 20 and 40 are in the retracted state, the flexible design of the cover device 80 allows it to lie between the two auxiliary flaps 20 and 40, thereby preventing the cover device 80 from negatively influencing the flow around the aerodynamic body.

Also depicted on FIG. 7 is another embodiment of the adjustment device 60. At least sections of at least one auxiliary flap 20 here exhibit a shape memory material. A resistance heater placed in thermal contact to this material is provided, and already comprises one of the adjustment devices. If current is now passed through the resistance heater to make it operational, the shape memory material is also heated, and deforms accordingly. After cooling, which can take place actively or passively, the shape memory material deforms back into its original shape. In this way, the resistance heater serves as an adjustment device 60 for adjusting the corresponding auxiliary flap 20. Of course, the same adjustment device can also be provided for all additional auxiliary flaps 40.

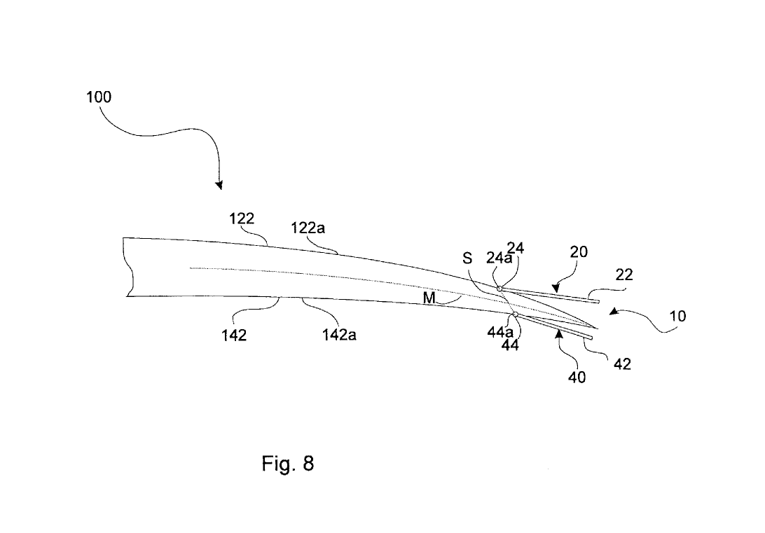

As an illustration of the wide range of potential applications for an auxiliary flap arrangement 10 according to the invention or an aerodynamic body 100 according to the present invention, FIG. 8 shows an embodiment in which the aerodynamic body 100 involves an assembly that is fixed in place relative to an aircraft. For example, this can be the wing of a primary wing, which is equipped with an auxiliary flap arrangement 10. In particular, the profile for the flow around the aerodynamic body 100 is here not symmetrical, so that the setting angles 128 and 148 of the two auxiliary flaps 20 and 40 are defined using not the center line M, but rather the tangent at the center line M in the intersecting point S of the connections of the two mounting devices 24 and 44. In the embodiment of an aerodynamic body 100 as a fixed assembly, the climbing power is elevated by employing the auxiliary flaps 20 and 40 on the one hand, while the stability of the aerodynamic body 100 during flight operations can be improved by using, i.e., adjusting, the auxiliary flaps 20 and 40. As an advantageous result, the improved in-flight comfort is accompanied by less need to use the steering flaps, so that the overall drag while cruising is also improved in situations wherein instability develops.

The embodiments described above only represent examples of the present invention, and do not limit the latter in any way. Of course, the individually described ideas for solutions can also be freely combined with each other where technically feasible.

### REFERENCE LIST

10 Auxiliary flap arrangement

20 First auxiliary flap

22 Outer flow contour

24 First mounting device

24a First mounting

26 First trailing edge

40 Second auxiliary flap

42 Outer flow contour

44 Second mounting device

44a Second mounting

46 Second trailing edge

60 Adjustment device

80 Cover device

82 Opening

100 Aerodynamic body

122 First body contour

122a Outer flow contour

128 First setting angle

142 Second body contour

142a Outer flow contour

148 Second setting angle

M Center line

RA Edge section

S Intersecting point

1. An auxiliary flap arrangement for modifying the profile of an aerodynamic body and extending in a chord direction, the auxiliary flap arrangement comprising:
at least one first auxiliary flap having a first outer flow contour and a first mounting for mounting the first auxiliary flap in a first mounting device of the aerodynamic body, with which the first auxiliary flap can be adjusted relative to the aerodynamic body,
at least one second auxiliary flap having a second outer flow contour and a second mounting for mounting the second auxiliary flap in a second mounting device of the aerodynamic body, with which the second auxiliary flap can be adjusted relative to the aerodynamic body,
an adjustment device for coupling the adjustment of the first auxiliary flap with the adjustment of the second auxiliary flap in such a way that when the adjustment device is activated, at least overall, both auxiliary flaps are adjusted oppositely to each other in relation to the chord direction of the aerodynamic body.

2. An aerodynamic body for attachment to an aircraft, comprising
a first body contour that forms a first outer flow contour and a second body contour that forms a second outer flow contour, which is aligned opposite the alignment of the first outer flow contour in relation to the chord direction of the aerodynamic assembly,
at least one auxiliary flap arrangement with the features of claim 1, which is arranged on the aerodynamic body in such a way that the first outer flow contour of the first auxiliary flap in conjunction with the first body contour forms the first outer flow contour, while the second outer flow contour of the second auxiliary flap in conjunction with the second body contour forms the second outer flow contour of the aerodynamic body.

3. The aerodynamic body according to claim 2, characterized in that the auxiliary flap arrangement is arranged on the aerodynamic body in such a way that, viewed in the direction of flow, the two outer flow contours of the two auxiliary flaps form the respective rear edge section of the first outer flow contour as well as the second outer flow contour of the aerodynamic body.

4. The aerodynamic body according to claim 3, characterized in that the rear edge sections comprise in the chord direction less than 40% of the overall respective outer flow contour of the aerodynamic body.

5. The aerodynamic body according to claim 2, characterized in that at least one of the two outer flow contours of the two auxiliary flaps comprises in the chord direction 1 to 2% of the corresponding outer flow contour of the aerodynamic body.

6. The aerodynamic body according to claim 2, characterized in that a first setting angle and a second setting angle are defined between the tangents on the respective outer flow contour of the two auxiliary flaps and the tangents on the corresponding body contour in the mounting axes formed by the mounting devices, and that the two setting angles are less than 45°.

7. The aerodynamic body according to claim 2, characterized in that the two trailing edges of the two outer flow contours of the two auxiliary flaps are connected with a shared cover in relation to the direction of flow, which is configured to cover an opening created by adjusting the two outer flow contours of the two auxiliary flaps.

8. The aerodynamic body according to claim 2, characterized in that the first outer flow contour of the first auxiliary flap is adjusted around the first mounting axis and the second outer flow contour of the second auxiliary flap is adjusted around the second mounting axis symmetrically to the tangent at the center line of the aerodynamic body at the point of intersection with the connecting straight line of the two mounting axes.

9. The aerodynamic body according to claim 2, characterized in that the transition of the two outer flow contours of the aerodynamic body between the respective body contour and respective outer flow contour of the two auxiliary flap takes place continuously, in particular with a constant rise.

10. The aerodynamic body according to claim 2, characterized in that the auxiliary flap arrangement is designed in such a way that the maximum distance achievable by adjusting the two outer flow contours of the two auxiliary flaps between the trailing edges of the two outer flow contours of the two auxiliary flaps relative to the direction of flow measures between 0.4 and 2% of the extension of the aerodynamic body along the direction of flow.

11. The aerodynamic body according to claim 2, characterized in that the auxiliary flap arrangement is designed in such a way that the maximum distance achievable by adjusting the two outer flow contours of the two auxiliary flaps between the trailing edges of the two outer flow contours of the two auxiliary flaps relative to the direction of flow lies between 2 to 10 times the minimum distance between the trailing edges of the two counter flow contours of the two auxiliary flaps relative to the direction of flow achievable by adjusting the two outer flow contours of the two auxiliary flaps.

12. The aerodynamic body according to claim 2, characterized in that the aerodynamic body is an aerodynamic body that can move relative to the attachment structure of an aircraft.

13. The aerodynamic body according to claim 12, characterized in that the adjustment device of the auxiliary flap arrangement is configured such that the adjustment state of the two outer flow contours of the two auxiliary flaps is coupled with the movement state of the aerodynamic body.

14. An aircraft comprising at least one aerodynamic body with the features of claim 2.
